(19) United States
(12) Patent Application Publication
(10) Pub. No.: US 2002/0066413 A1
(43) Pub. Date: Jun. 6, 2002

(54) Portable animal bowl feeder

(76) Inventor: Eric Prezant, Chicago, IL (US)

Correspondence Address: Welsh & Katz, Ltd., Richard J. Gurak, 22nd Floor, 120 South Riverside Plaza, Chicago, IL, 60606, US

(21) Appl. No.: 09/728,907

(22) Filed: Dec. 5, 2000

(51) Int. Cl. A01K 5/01

(52) U.S. Cl. 119/61

(57) ABSTRACT

An improved portable animal feeder which comprises a light-weight animal bowl feeder which may be folded so it is compact, low profile and portable. Attached to the bowl may be straps for securing the bowl to an animal's leash or collar. In other forms of the invention, a pouch may be provided that attaches to a leash or collar and provides storage for the animal bowl feeder.

### FIELD OF THE INVENTION

The present invention relates to animal feeding devices, and more particularly to portable bowls for supplying food and drink to a pet.

### BACKGROUND OF THE INVENTION

The use of animal feeding devices is known in the prior art. Existing feeding devices often are used to hold water, food or both so as to conveniently provide nourishment for an animal.

While these devices generally fulfill their respective, particular objectives and requirements, they do not provide for an animal feeding device that is conveniently compact, light-weight, and portable. Most animals, especially domestic animals such as dogs, travel away from their home several times a day. In this regard, a dog owner may take her dog for a walk in a park, by a lake or around a neighborhood. During the excursion, especially ones of long duration, the dog may require water and/or food. The present invention is easily taken along during these excursions so as to provide a light-weight, portable, collapsible, and compact feeding device that may attach to the pet's leash or collar. The present invention provides a portable animal bowl feeder.

The principal object of the present invention is to provide an improved portable animal bowl feeder.

Still another object of the present invention is to provide a novel portable animal bowl feeder that may fold into a compact size.

Another object of the present invention is to provide a novel portable animal bowl feeder that may attach to an animal's leash or collar.

Yet another object of the present invention is to provide a novel portable animal bowl feeder that when folded and attached to an animal's leash or collar, the folded bowl minimally projects outward from the leash or collar.

A further object of the present invention is to provide a novel portable animal bowl feeder that may be an integral component of an animal's leash or collar.

A further object of the present invention is to provide a novel portable animal bowl feeder that is light-weight.

A further object of the present invention is to provide a novel portable animal bowl feeder which is simple in design and inexpensive to construct, and is durable and rugged in structure.

Still further objects and advantages will become apparent from a consideration of the ensuing description and drawings of the invention.

These and other objects are achieved by a portable animal bowl feeder of the present invention. In one form of the invention, a portable animal bowl feeder is provided which comprises a light-weight animal bowl feeder which may be folded so it is compact, low profile and portable. Attached to the bowl may be straps for securing the bowl to an animal's leash or collar. In other forms of the invention, a pouch may be provided that attaches to a leash or collar and provides storage for the portable animal bowl feeder.

### BRIEF DESCRIPTION OF THE DRAWINGS

FIG. 1 is a perspective view of one embodiment of the portable animal bowl feeder of the present invention;

FIG. 2 is a bottom view of the portable animal bowl feeder of FIG. 1;

FIG. 3 is a side view of the portable animal bowl feeder of FIG. 1;

FIG. 4 is a top view of a the portable animal bowl feeder of FIG. 1 shown folded;

FIG. 5 is a perspective view of a the portable animal bowl feeder of FIG. 1 shown folded and attached to an animal's leash; and

FIG. 6 is a top view of one embodiment of a pouch of the present invention.

### DETAILED DESCRIPTION OF THE INVENTION

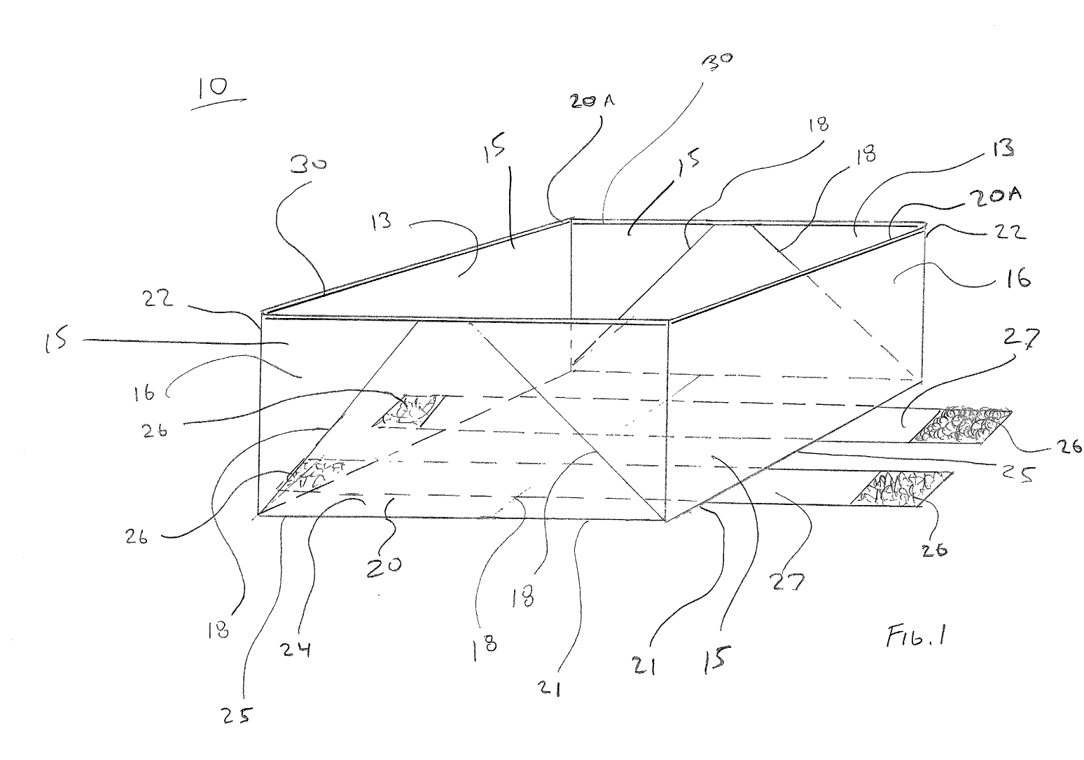

FIG. 1 is a perspective view of one embodiment of the portable animal bowl feeder 10 constructed in accordance with the present invention. As shown in FIG. 1, one embodiment of the invention may include a bowl 10 including one or more wall portions 15, a bottom portion 20 and one or more straps 27.

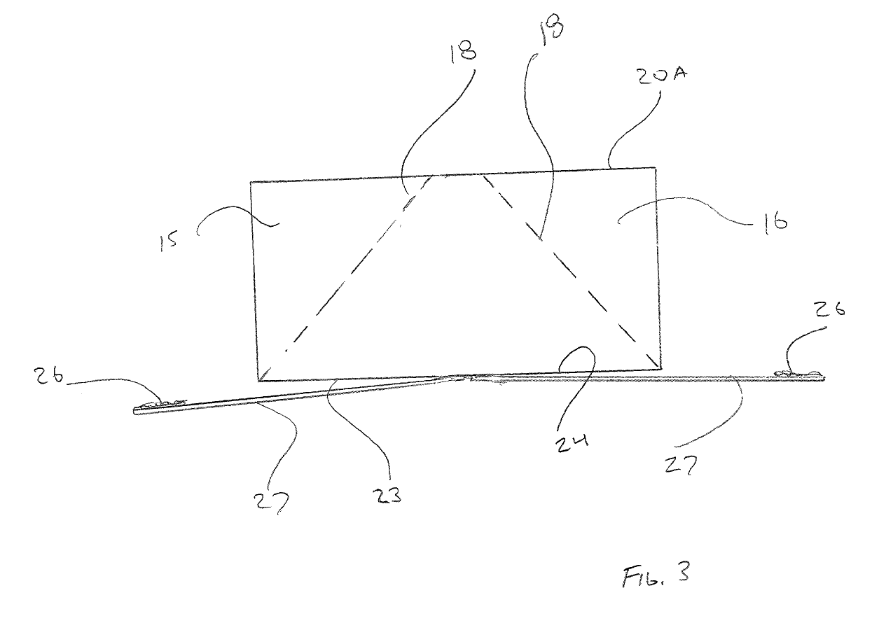

One or more wall portions 15 may be provided, in one embodiment, to form a substantially square shaped bowl 10 as shown in FIGS. 1, 2, and 3. As shown in FIG. 1, wall portions 15 may have a top edge 20A, a bottom edge 21, a side edge 22, an inner surface 13 and/or an outer surface 16. Individual wall portions 15 may be formed from a single piece of material or from multiple pieces of material joined along their respective edges to form a wall portion 15. In alternate embodiments, wall portions 15 may include one layer of material or may include a plurality of layers of material that are attached to one another.

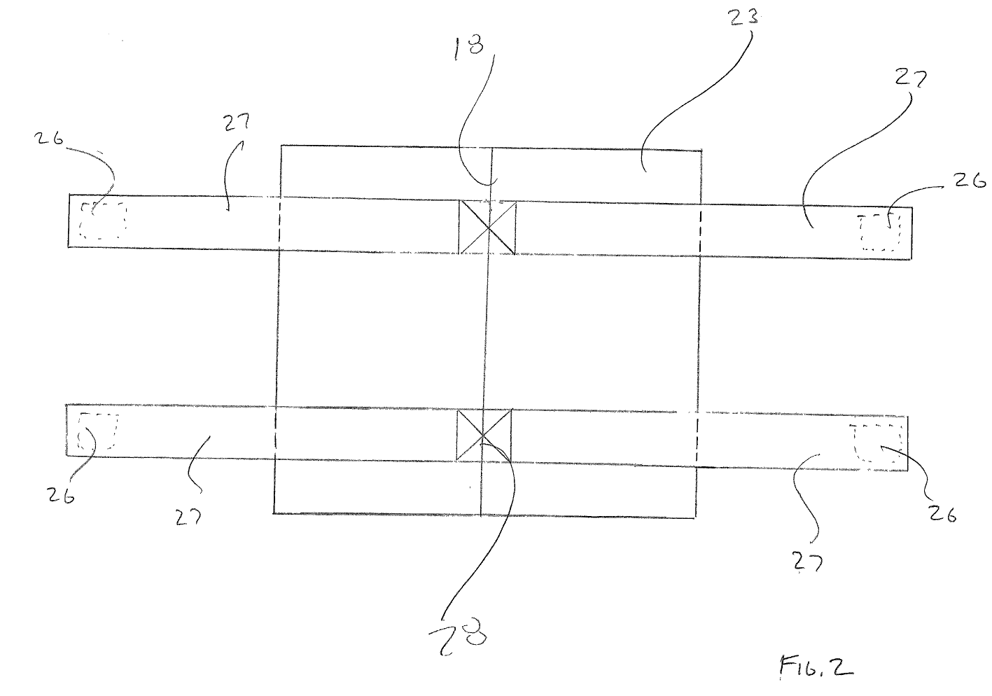

In one embodiment, one or more bottom portions 20 may be provided to form a substantially square shaped bowl 10 as shown in FIGS. 1, 2, and 3. As shown in FIGS. 1 and 2, bottom portion 20 may have an outer bottom surface portion 23, an inner surface portion 24 and/or one or more edges 25. Individual bottom portions 20 may be formed from a single piece of material or from multiple pieces of material joined along their respective edges to form a bottom portion 20. In alternate embodiments, bottom portion 20 may include one layer of material or may include a plurality of layers of material that are attached to one another.

As shown in FIGS. 1, 2, and 3, one embodiment of the portable animal bowl feeder 10 may be substantially square in shape. In this embodiment, the bowl 10 may include four wall portions 15 and one bottom portion 20. Wall portions 15 may include four individual and separate wall portions 15 that may be connected to each other at adjoining wall side edges 22 to form a single bowl 10 wall having a substantially square-shaped top edge 20A perimeter and bottom edge 21 perimeter after the wall portions 15 are joined to each other. In another embodiment, wall portions 15 may be constructed from a single piece of material having two side edges 22. When the two side edges 22 are joined together and the material is appropriately bent, configured and/or shaped, four wall portions 15 may be formed from one piece of material. In yet other embodiments, bowl 10 may be formed substantially as shown in FIGS. 1, 2, and 3 by forming both wall portions 15 and bottom portions 20 from one piece of material. In this embodiment, after the material is cut to the appropriate shape and size, the appropriate edges may be sealably joined, as described herein, and a bowl 10 may be formed substantially in a square shape as shown in FIG. 1.

In one embodiment as shown in FIGS. 1, 2, and 3, bottom portion 20 may be provided and sealably joined to bottom edges 21 of wall portions 15 so as to provide a bowl 10 shaped substantially as in FIG. 1. Bottom portion 20 may be joined to wall portions 15 in a variety of different ways, for example by, adhesive, heat treatment, stitching, mechanical fasteners or any other way that will provide a water-proof seal between bottom edge 25 and side edge 22.

In still yet other embodiments, a thin, foldable wire or other shape keeping device 30 may be provided to facilitate keeping the wall top edges 20A in an open position as shown in FIG. 1. In this embodiment, the wire 30 may be positioned so that it extends substantially around the entire perimeter of wall top edges 20A as shown in FIG. 1. In one embodiment, the wire 30 may be located either adjacent the inner surface 13 or outer surface 16. Wire 30 may be attached to wall 15 in a variety of different ways, for example by, adhesive, heat treatment, stitching, mechanical fasteners or any other way that will provide for proper operation of bowl 10. In still yet other embodiments, other shape keeping devices may be substituted for wire 30, for example, bendable plastic strips, rubber strips or any other device that may maintain the shape of bowl 10 substantially as shown in FIG. 1 and provide for proper operation of bowl 10.

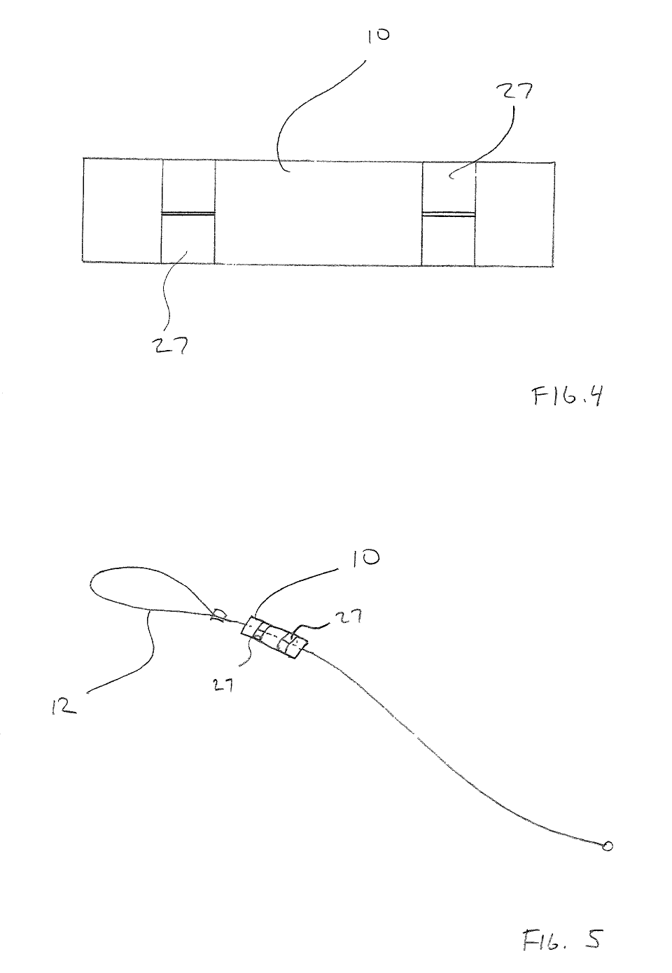

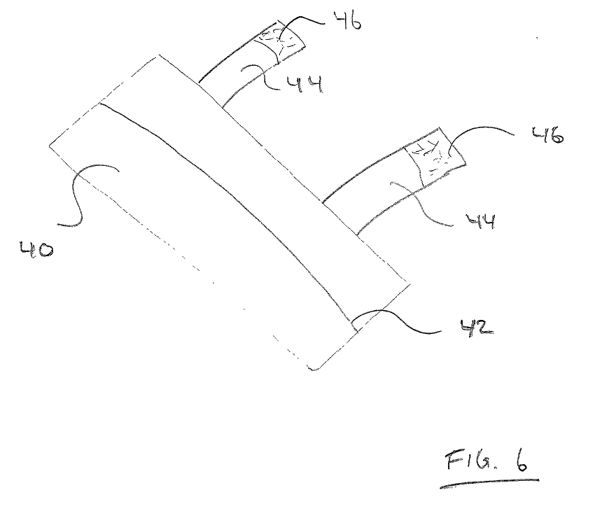

In yet other embodiments, one or more straps 27 as shown in FIGS. 1-5 may be provided for bowl 10. As shown in FIGS. 1-5, two straps 27 may be attached to the bottom outer surface portion 23. The straps 27 may have a strap fastener 26 located on the end of the strap 27 as shown in FIGS. 1 and 2 or located anywhere else on the strap 27. The strap fasteners 26 may be hook and loop fasteners, mechanical fasteners, such as snaps for example, or any other device that will maintain the straps 27 in an attached as shown in FIGS. 4 and 5. The straps 27 may be attached to the bottom outer surface portion 23 in a variety of different ways, for example by, adhesive, heat treatment, stitching, mechanical fasteners and any other way that will provide for proper operation of bowl 10. In still yet other embodiments, other devices may be substituted for straps 27, for example, bendable plastic strips, rubber strips, string or any other device. The straps may be constructed of any bendable or foldable material such as, for example, cloth, plastic, or any other type of material that will provide for proper operation of bowl 10. As shown in FIG. 5, the straps 27 may wrap around an animal leash 12 so as to provide for folded bowl 10 to be removable yet securely positioned anywhere along the length of leash 12. The straps 27 may also be used to attach the bowl 10 to an animal's collar. In other embodiments, bowl 10 may attach directly to leash 12 (or a collar) without straps 27. In this embodiment, fasteners may be provided and attached to bowl 10 and to leash 12. For example, hook and loop fasteners may be used by attaching them to bowl 10 and to a portion of leash 12 whereby when bowl 10 is positioned adjacent the respective hook and loop fastener attached to leash 12, bowl 10 will be maintained removable yet securely attached to leash 12.

Bowl 10, in another embodiment, may have fold lines 18 along wall portions 15 and bottom portion 20 substantially as shown in FIGS. 1, 2 and 3. The fold lines 18 may facilitate the folding of bowl 10 along fold lines 18. As shown in FIG. 1, in one embodiment, one or more wall portions may each have two fold lines 18 where each fold line 18 starts substantially from a lower corner of wall portion 15 and extends substantially along the wall portion 15 up towards substantially the center of the top edge 20A of wall portion 15. In one embodiment, the fold lines 18 may be constructed in a variety of different ways, for example, the lines 18 may be formed from weakened sections of the material that bowl 10 is made of, may be formed from creases that are created in the material by heat treatment or may be formed in any other way that will provide for proper operation of bowl 10. As shown in FIG. 2, bottom portion 20 may also have one or more fold lines 18 along substantially the entire length and/or width of bottom portion 20.

In yet other embodiments of bowl 10, bowl 10 may be formed in many different shapes. For example, bowl 10 top edge 20A perimeter may form a shape that is substantially circular, triangular, octagonal, hexagonal, or any other shape that would provide for proper operation of bowl 10. Bowl 10 may be of a variety of different dimensions such as, for example, 4″×4″×2″, 5″×5″×2.5″, 6″×6″×3″ or any other combinations of dimensions depending on the size of the animal that will use bowl 10.

In one embodiment, the material used to construct bowl 10 may be any material that is substantially thin and flexible. For example, the material may be any type of cloth, plastic, cardboard, or other material. The material may be made of different colors, designs and patterns. The material may be substantially water-proof or may be made water-proof by applying a coating to the material. For example, a water-proof spray coating that is safe for animals may be applied to the material. In yet other embodiments, a thin plastic liner may be positioned inside bowl 10 to provide a water-proof bowl 10. Other types of water-proof liners may also be positioned inside of bowl 10.

Bowl 10 may also be provided with a pouch 40 as shown, in one embodiment, in FIG. 6. Pouch 40 may include an opening 42 and one or more straps 44 with strap attachments 46. Pouch 40 may be made large enough to allow for bowl 10 to fit inside pouch 40 and be easily removed through opening 42. Opening 42 may have a closure device such as, for example, a zipper or hook and loop fasteners that will prevent bowl 10 from falling out of pouch 40. The material used to construct pouch 40 may be any material that is substantially thin and flexible. For example, the material may be any type of cloth, plastic or other material. The material may be made of different colors, designs and patterns. The material may be substantially water-proof or may be made water-proof by applying a coating to the material. For example, a water-proof spray coating that is safe for animals may be applied to the material. The straps 44 may have a strap attachment 46 located on the end of the strap 44 as shown in FIG. 6 or located anywhere else on the strap 44. The strap attachments 46 may be hook and loop fasteners, mechanical fasteners, such as snaps for example, or any other device that will maintain the straps 44 attached to an animal leash or collar. The straps 44 may be attached to pouch 40 in a variety of different ways, for example, by adhesive, heat treatment, stitching, mechanical fasteners and any other way that will provide for strap 44 to be attached to pouch 40. In still yet other embodiments, other devices may be substituted for straps 44, for example, bendable plastic strips, rubber strips, string or any other device that may provide for the pouch 40 to removably attach to an animal's leash or collar. The straps may be constructed of any bendable or foldable material such as, for example, cloth, plastic, or any other type of material that will provide for pouch 40 to be attached to an animal's leash or collar. In other embodiments, pouch 40 may attach directly to leash 12 (or a collar) without straps 44. In this embodiment, fasteners may be provided and attached to pouch 40 and to leash 12. For example, hook and loop fasteners may be used by attaching them to pouch 40 and to a portion of leash 12 whereby when pouch 40 is positioned adjacent the respective hook and loop fastener attached to leash 12, pouch 40 will be maintained removable yet securely attached to leash 12. In one embodiment, pouch 40 may be an integral part of an animal's leash 12 whereby the leash and pouch are purchased as a single article. In yet other embodiments, pouch 40 may be an integral part of an animal's leash 12 whereby the leash, pouch 40 and bowl 10 are purchased as a single article.

In use, when walking a pet, the bowl 10 may be removed from the pet's leash 12 (or collar) by removing straps 27 from leash 12 (or collar). The user may then unfold bowl 10 and put either food or water into bowl 10 so as to provide nourishment for the pet. After the pet is finished using bowl 10, bowl 10 may be easily folded and secured on the pet's leash 12 (or collar).

Specific embodiments of novel methods and apparatus for construction of novel portable animal bowl feeders according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A portable animal feeder that can be attached to an animal's leash or collar, comprising:
a foldable bowl; and
a securing means attached to the bowl whereby the securing means can removably attach the bowl to the leash or collar.

2. The portable animal feeder of claim 1 further including a pouch that the bowl can fit inside.

3. The portable animal feeder of claim 2 wherein the pouch comprises a securing means that can removably attach the pouch to the animal's leash or collar.

4. The portable animal feeder of claim 3 wherein the securing means comprises at least one strap attached to the pouch.

5. The portable animal feeder of claim 4 wherein the strap further comprises a fastening means.

6. The portable animal feeder of claim 1 wherein the bowl further comprises at least one fold line positioned on at least one bowl side whereby the at least one fold line facilitates folding of the bowl.

7. The portable animal feeder of claim 6 wherein the bowl further comprises at least one fold line positioned on the bowl bottom whereby the at least one fold line facilitates folding of the bowl.

8. The portable animal feeder of claim 1 wherein the bowl further comprises a means for maintaining the bowl in an open position.

9. The portable animal feeder of claim 8 wherein the means for maintaining the bowl in an open position is a wire attached to substantially the entire upper portion of the bowl walls.

10. The portable animal feeder of claim 1 wherein the bowl is substantially square shaped.

11. A portable animal feeder, comprising:
a foldable bowl; and
a pouch having an opening that can accept the bowl and allow the bowl to fit inside the pouch.

12. The portable animal feeder of claim 11 wherein the pouch comprises a means for removably securing the pouch to an animal's leash or collar.

13. The portable animal feeder of claim 12 wherein the means for removably securing comprises at least one strap attached to the pouch.

14. The portable animal feeder of claim 13 wherein the strap further comprises a fastening means.

15. The portable animal feeder of claim 11 wherein the bowl further comprises at least one fold line positioned on at least one bowl side whereby the at least one fold line facilitates folding of the bowl.

16. The portable animal feeder of claim 15 wherein the bowl further comprises at least one fold line positioned on the bowl bottom whereby the at least one fold line facilitates folding of the bowl.

17. The portable animal feeder of claim 11 wherein the bowl further comprises a means for maintaining the bowl in an open position.

18. The portable animal feeder of claim 11 wherein the means for maintaining the bowl in an open position is a wire attached to substantially the entire upper portion of the bowl walls.

19. A method for providing nourishment to an animal, comprising the steps of:
providing a portable foldable bowl that is removably attached to an animal's leash or collar; and
removing the bowl from the leash or collar.

20. The method of claim 19 further comprising the step of providing a pouch having an opening that can accept the foldable bowl and provide for the foldable bowl to fit inside the pouch; and removably securing the pouch to the animal's leash or collar.
